(19) United States
(12) Patent Application Publication
(10) Pub. No.: US 2024/0395233 A1
(43) Pub. Date: Nov. 28, 2024

(54) Machine-Learned Models for Generation of Musical Accompaniments Based on Input Vocals

(71) Applicant: Google LLC, Mountain View, CA (US)

(72) Inventors: Adam Joseph Roberts, Chapel Hill, NC (US); Jesse Hart Engel, Orinda, CA (US); Ian Stuart Simon, San Francisco, CA (US); Andrea Agostinelli, Zurich (CH); Neil Zeghidour, Paris (FR); Christopher James Donahue, Pittsburgh, PA (US); Antoine Caillon, Paris (FR)

(21) Appl. No.: 18/671,577

(22) Filed: May 22, 2024

Related U.S. Application Data
(60) Provisional application No. 63/503,614, filed on May 22, 2023.

(51) Int. Cl. G10H 1/00; G10H 1/36; G10L 15/06; G10L 15/18; G10L 15/183

(52) U.S. Cl. CPC G10H 1/0025; G10H 1/361; G10L 15/063; G10L 15/1815; G10L 15/183; G10H 2210/005; G10H 2210/111; G10H 2220/101

(57) ABSTRACT

Training data comprising a plurality of training pairs is obtained. Each training pair comprises instrumental audio data and vocal audio data separated from audio data of a musical work of a respective plurality of musical works. For one or more training pairs of the plurality of training pairs, the vocal audio data is processed with machine-learned model(s) of a machine-learned generative audio model grouping to obtain a vocal intermediate representation for the vocal audio data. The instrumental audio data is processed with a pre-trained encoding model to obtain an instrumental intermediate representation for the instrumental audio data. A loss function is evaluated that evaluates a difference between the vocal intermediate representation and the instrumental intermediate representation. Values of parameters of a machine-learned model of the machine-learned generative audio model grouping are modified based on the loss function.

### PRIORITY CLAIM

The present application is based on and claims priority to U.S. Provisional Application 63/503,614 having a filing date of May 22, 2023, which is incorporated by reference herein.

### FIELD

The present disclosure relates generally to generative machine learning models. More particularly, the present disclosure relates to generative models for generation of musical accompaniments (e.g., instrumentals) for input vocals (e.g., singing).

### BACKGROUND

In recent years, machine-learned models have been used to generate various types of data (e.g., textual content, audio data, video data, 3D modeling data, etc.) in an increasingly sophisticated manner. For example, generative text models have been trained to generate textual content in a conversational pattern based on input prompts. In some circumstances, multiple machine-learned models are used in conjunction to generate outputs. For example, a grouping of models that produces video data as a final output may include models trained to encode/decode textual content as an intermediate output.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes obtaining training data comprising a plurality of training pairs, each training pair comprising instrumental audio data and vocal audio data separated from audio data of a musical work of a respective plurality of musical works. The method includes, for one or more training pairs of the plurality of training pairs, processing, by the computing system, the vocal audio data with one or more machine-learned models of a plurality of machine-learned models of a machine-learned generative audio model grouping to obtain a vocal intermediate representation for the vocal audio data. The method includes processing, by the computing system, the instrumental audio data with one or more pre-trained encoding models to obtain an instrumental intermediate representation for the instrumental audio data. The method includes evaluating, by the computing system, a loss function that evaluates a difference between the vocal intermediate representation and the instrumental intermediate representation. The method includes modifying, by the computing system, values of parameters of at least one of the one or more machine-learned models of the machine-learned generative audio model grouping based on the loss function.

Another example aspect of the present disclosure is directed to one or more non-transitory computer-readable storage media that store instructions that, when executed by one or more processors, cause the one or more processors to perform operations. The operations include obtaining, from a user computing device, user audio data that comprises vocal audio produced by a user of the user computing device. The operations include processing the user audio data with a machine-learned generative audio model grouping to obtain predicted instrumental audio data comprising instrumental audio that corresponds to the vocal audio produced by the user of the user computing device, wherein the machine-learned generative audio model grouping comprises a plurality of machine-learned models, and wherein at least one of the plurality of machine-learned models is trained using training data that comprises, or is derived from, a plurality of musical works, each musical work being separated into instrumental audio data and vocal audio data. The operations include mixing the user audio data and the predicted instrumental audio data to obtain musical audio data that comprises a musical work. The operations include transmitting the musical audio data to the user computing device.

Another example aspect of the present disclosure is directed to a user computing device. The user computing device includes one or more processors, and one or more non-transitory computer-readable media that store instructions that, when executed by the one or more processors, cause the one or more processors to perform operations. The operations include obtaining, via an audio capture device associated with the user computing device, user audio data that comprises vocal audio produced by a user of the user computing device. The operations include processing the user audio data with a machine-learned generative audio model grouping to obtain predicted instrumental audio data comprising instrumental audio that corresponds to the vocal audio produced by the user of the user computing device, wherein the machine-learned generative audio model grouping comprises a plurality of machine-learned models, and wherein at least one of the plurality of machine-learned models is trained using training data that comprises, or is derived from, a plurality of musical works, each musical work being separated into instrumental audio data and vocal audio data. The operations include mixing the user audio data and the instrumental audio data to obtain musical audio data that comprises a musical work. The operations include providing the musical audio data for playback for the user.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs instrumental audio generation according to example embodiments of the present disclosure.

FIG. 1B depicts a block diagram of an example computing device that performs training of a machine-learned generative audio model grouping according to example embodiments of the present disclosure.

FIG. 1C depicts a block diagram of an example computing device that performs provision of machine-learned generative audio services according to example embodiments of the present disclosure.

FIG. 2 depicts a block diagram of an example machine-learned generative audio model grouping according to example embodiments of the present disclosure.

FIG. 3A depicts a data flow diagram for training machine-learned model(s) included in a machine-learned generative audio model grouping according to some implementations of the present disclosure.

FIG. 3B depicts a data flow diagram for processing vocal audio data with encoding models for training of model(s) included in a machine-learned generative audio model grouping according to some implementations of the present disclosure.

FIG. 3C depicts a data flow diagram for processing instrumental audio data with pre-trained encoding models for training of model(s) included in a machine-learned generative audio model grouping according to some implementations of the present disclosure.

FIG. 4A depicts a data flow diagram for generating instrumental audio data to accompany vocal audio produced by a user with a machine-learned generative audio model grouping of a server computing system according to some implementations of the present disclosure.

FIG. 4B is a data flow diagram for generating predicted instrumental audio data using a machine-learned generative audio model grouping according to some implementations of the present disclosure.

FIG. 5 depicts a flow chart diagram of an example method to perform training of a machine-learned generative audio model grouping according to example embodiments of the present disclosure.

FIG. 6 depicts a flow chart diagram of an example method to provide machine-learned generative audio services for generation of instrumental accompaniments according to example embodiments of the present disclosure.

FIG. 7 depicts a flow chart diagram of an example method to utilize machine-learned generative audio services to provide musical accompaniments to user audio data that includes vocal audio from the user according to example embodiments of the present disclosure.

Reference numerals that are repeated across plural figures are intended to identify the same features in various implementations.

### DETAILED DESCRIPTION

### Overview

Generally, the present disclosure is directed to generative machine learning models. More particularly, the present disclosure relates to generative models for generation of musical accompaniments (e.g., instrumentals) for input vocals (e.g., singing). For example, a computing system (e.g., a computing system providing an audio generation service, a user computing device, etc.) can obtain training data that includes a plurality of training pairs. Each training pair can be formed by separating the audio data of a musical work (e.g., a song) into vocal audio data (e.g., audio produced by a singer) and instrumental audio data (e.g., audio produced by instruments, digitally produced audio, etc.). The computing system can process the vocal audio data with model(s) of a machine-learned generative audio model grouping to obtain an intermediate representation of the vocal audio data. The computing system can also process the instrumental audio data with pre-trained encoding model(s) to obtain an intermediate representation of the instrumental audio data. The computing system can train model(s) of the generative audio model grouping to minimize the difference between the two intermediate representations.

After training the model(s) of the generative audio model grouping, the computing system can receive user audio data that includes vocal audio (i.e., singing) produced by a user. The computing system can process the user audio data with the generative audio model grouping to obtain predicted instrumental audio data. The computing system can mix user audio data and the predicted instrumental audio data to obtain musical audio data that includes a musical work. In such fashion, the computing system can train and utilize a model to generate accompanying instrumentals for vocal audio produced by a user.

Aspects of the present disclosure provide a number of technical effects and benefits. As one example technical effect and benefit, conventionally generating instrumental audio (e.g., the musical accompaniments for a song) can be prohibitively difficult, usually requiring multiple musicians with expertise in a variety of instruments, or technical expertise in digital music production. For example, an electronic music producer may spend hundreds of hours (or more) utilizing computing resources (e.g., memory, compute cycles, power, storage, energy, etc.) to continuously iterate on background music to accompany vocals produced by a singer. As such, users generally lack the capability to produce musical accompaniments for vocals as part of the creative process. However, implementations of the present disclosure can quickly and efficiently generate high-quality instrumental audio to accompany vocal audio produced by a user. In such fashion, implementations of the present disclosure enhance the creative process while substantially reducing the compute resources that would be required to create such instrumental audio conventionally.

With reference now to the Figures, example embodiments of the present disclosure will be discussed in further detail.

### Example Devices and Systems

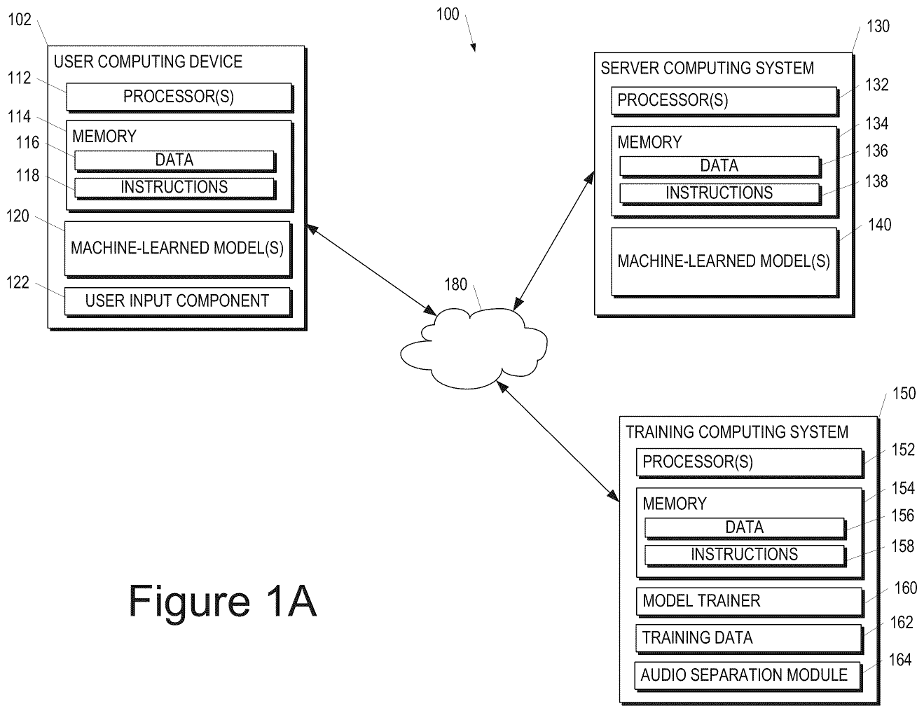

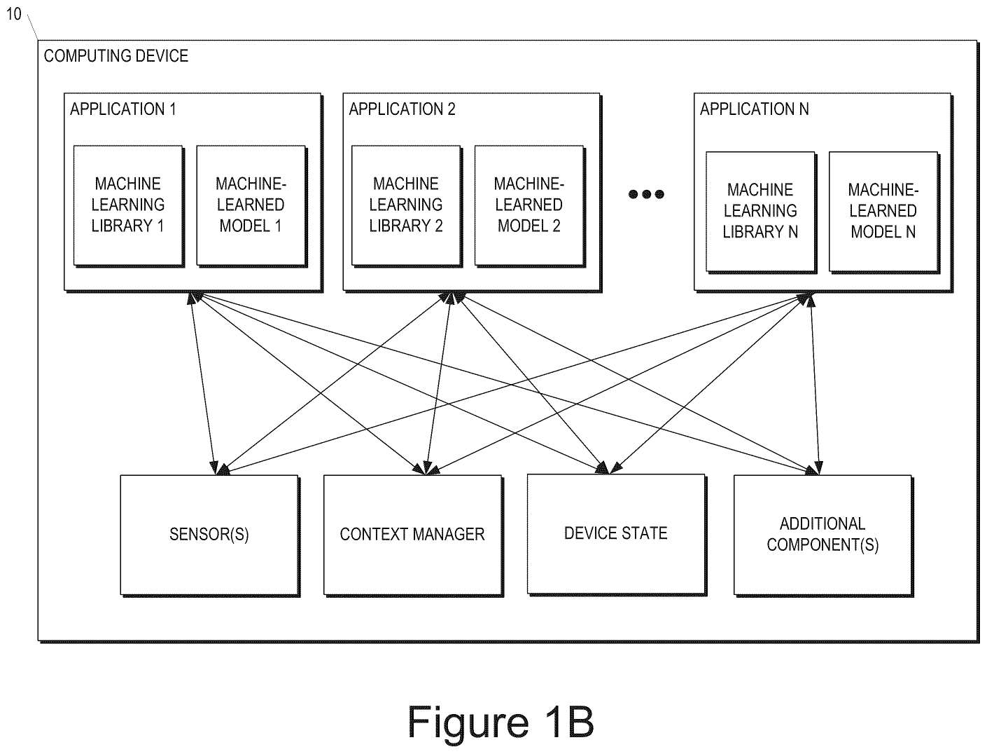

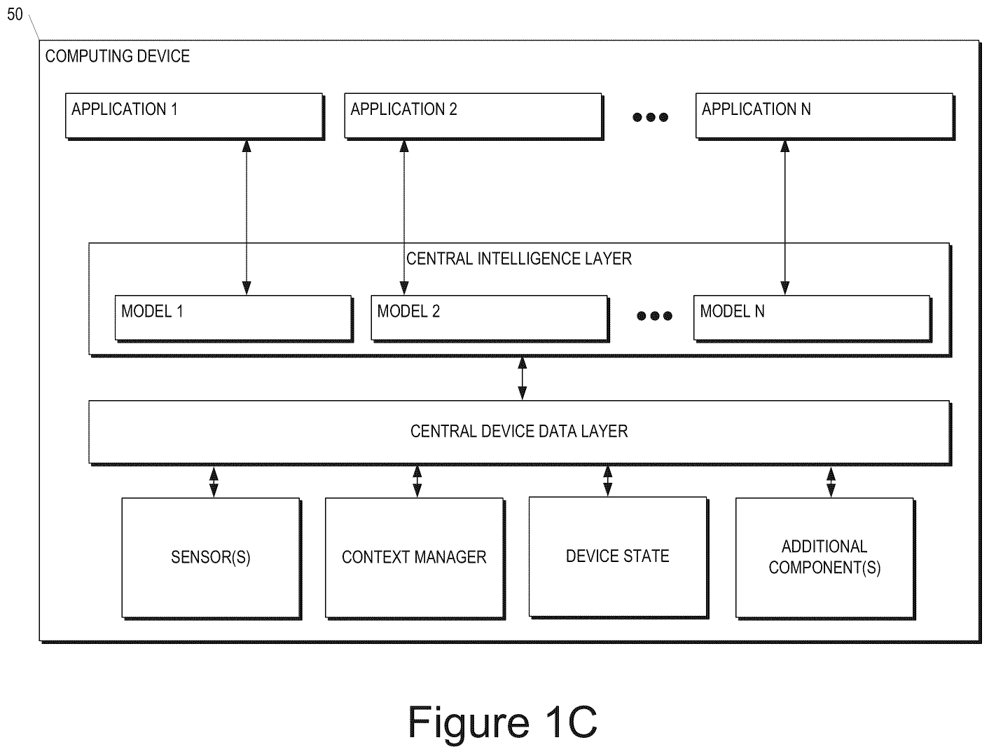

FIG. 1A depicts a block diagram of an example computing system 100 that performs instrumental audio generation according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

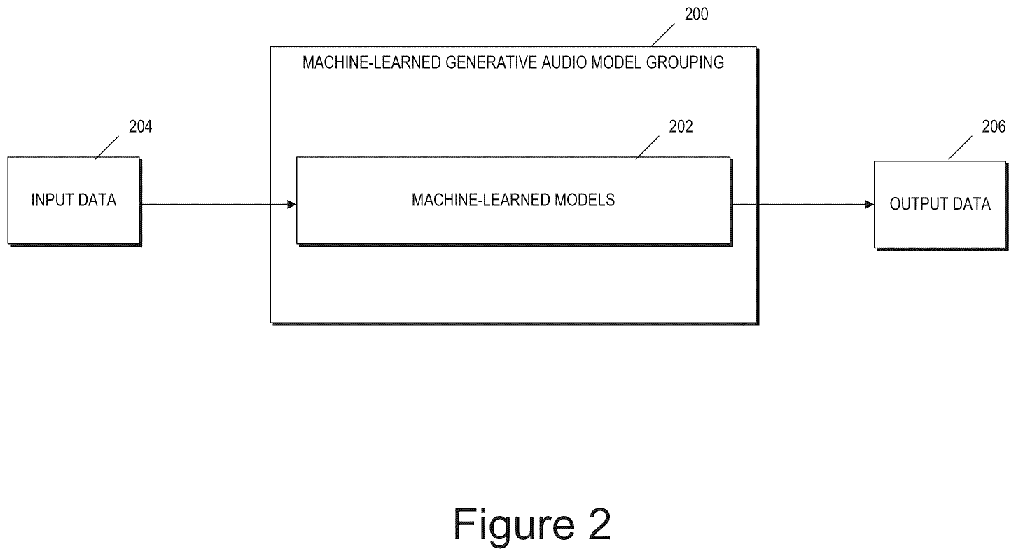

In some implementations, the user computing device 102 can store or include a plurality of machine-learned models for generation of audio, collectively referred to a machine-learned generative audio model grouping 120. For example, the machine-learned generative audio model grouping 120 can include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned generative audio model groupings 120 are discussed with reference to FIGS. 2-4.

In some implementations, the machine-learned generative audio model grouping 120 can be received from the server computing system 130 over network 180, stored in the user computing device memory 114, and then used or otherwise implemented by the one or more processors 112. In some implementations, the user computing device 102 can implement multiple parallel instances of a machine-learned generative audio model grouping 120 (e.g., to perform parallel instrumental audio generation across multiple instances of the machine-learned generative audio model grouping).

More particularly, the machine-learned generative audio model grouping 120 can include various machine-learned models that collectively can generate instrumental audio to accompany vocal audio produced by a user. For example, the machine-learned generative audio model grouping 120 can include encoding models (e.g., pre-trained text encoding models, audio encoding models, large language encoding models, etc.), decoding models (e.g., pre-trained text decoding models, audio decoding models, large language decoding models, etc.), transformer encoder-decoder models, etc.

Specifically, in some implementations, the machine-learned generative audio model grouping 120 can include pre-trained models that are utilized to train other models included in the machine-learned generative audio model grouping 120. Training of models within the machine-learned generative audio model grouping 120 will be discussed in greater detail with regards to the training computing system 150.

Additionally or alternatively, a machine-learned generative audio model grouping 140 can be included in or otherwise stored and implemented by the server computing system 130 that communicates with the user computing device 102 according to a client-server relationship. For example, the machine-learned generative audio model grouping 140 can be implemented by the server computing system 130 as a portion of a web service (e.g., a instrumental audio generation service). Thus, machine-learned generative audio model grouping 120 can be stored and implemented at the user computing device 102 and/or machine-learned generative audio model grouping 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include machine-learned generative audio model grouping 140. For example, the machine-learned generative audio model grouping 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned generative audio model grouping 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned generative audio model groupings 120 and/or 140 based on a set of training data 162. The training data 162 can include, for example, training pairs formed from vocal audio data and instrumental audio data separated from audio data of musical works.

More specifically, the training computing system 150 can obtain audio data for a number of musical works (e.g., songs that include vocals and instrumentals). The training computing system 150 can include an audio separation module 164 that can separate vocal audio data and instrumental audio data from the audio data of each musical work. In particular, the audio separation module 164 can separate vocal audio data and instrumental audio data using any conventional techniques (e.g., machine-learned audio separation models, audio separation algorithms, etc.). The module(s) and can utilize these module(s) to generate the training data 162 (e.g., the training pairs). Alternatively, the training computing system 150 can obtain the training data 162 from another source (e.g., via network(s) 180).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs training of a machine-learned generative audio model grouping according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs provision of machine-learned generative audio services according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example machine-learned generative audio model grouping 200 according to example embodiments of the present disclosure. In some implementations, the machine-learned generative audio model grouping 200 is trained to receive a set of input data 204 descriptive of vocal audio data including vocal audio produced by a user and, as a result of receipt of the input data 204, provide output data 206 that is descriptive of predicted instrumental audio data including instrumental audio that is predicted to correspond to the vocal audio produced by the user. Thus, in some implementations, the machine-learned generative audio model grouping 200 can include a plurality of machine-learned models 202 that is operable to process the vocal audio data to obtain the predicted instrumental audio data.

In particular, the machine-learned models 202 can include one or more encoding models. The encoding models can include pretrained encoding models and/or encoding models to be trained for generation of instrumental audio. For example, the machine-learned models 202 can include a pre-trained large language model trained to process input data 204 (e.g., vocal audio data) to obtain a semantic representation of the input data 204. The machine-learned models 202 can include a machine-learned audio representation model that can be trained to process the semantic representation, and/or the input data 204, to obtain a coarse acoustic representation of the input data 204. In some implementations, the machine-learned models 202 can include an encoding model that can process the coarse acoustic representation to obtain a fine acoustic representation, which can be decoded to obtain the predicted instrumental audio data. In such fashion, the machine-learned models 202 of the machine-learned generative audio model grouping 200 can be utilized to generatively predict instrumental audio data to accompany vocals provided by a user.

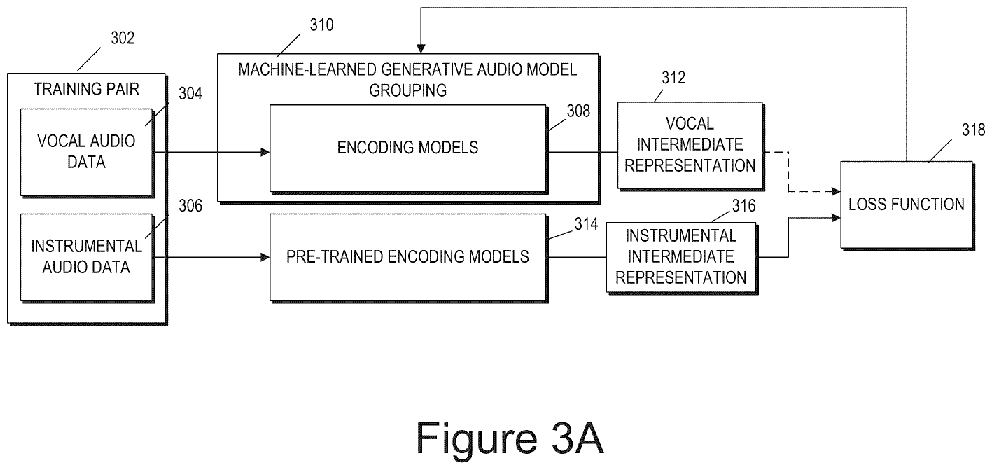

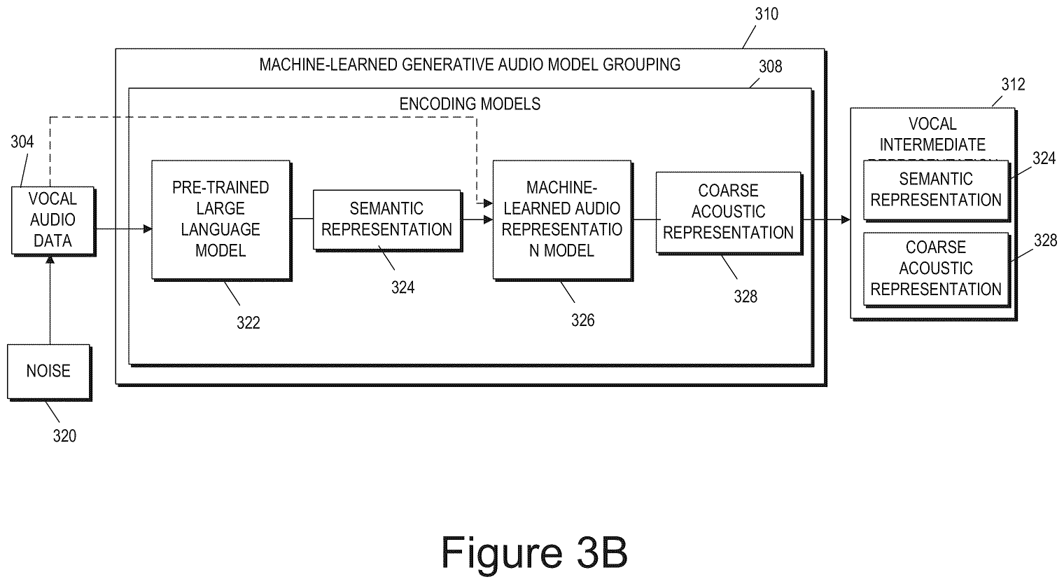

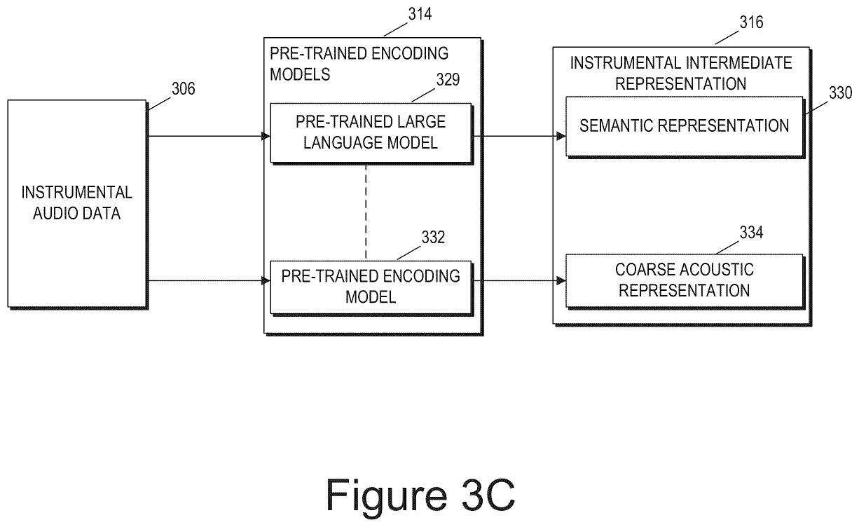

FIG. 3A depicts a data flow diagram for training machine-learned model(s) included in a machine-learned generative audio model grouping according to some implementations of the present disclosure. In particular, a computing system (e.g., server computing system 130 of FIG. 1A, training computing system 150, user computing device 102, etc.) can obtain a training pair 302. The training pair 302 can include vocal audio data 304 and instrumental audio data 306 separated from audio data of a musical work. In particular, although only one training pair 302 is illustrated herein, the computing system can obtain, and utilize, a large number of training pairs for training of model(s) within the machine-learned generative audio model grouping 310. For example, the computing system can obtain audio data for thousands of musical works that include both vocal audio and instrumental audio. The computing system can perform an audio separation process to form thousands of training pairs from the vocal audio data and instrumental audio data separated from the audio data of the musical works.

The computing system can process the vocal audio data with encoding models 308 (e.g., machine-learned models 202 of FIG. 2, etc.) of the machine-learned generative audio model grouping 310 (e.g., the machine-learned generative audio model grouping 200 of FIG. 2, etc.). By processing the vocal audio data with the encoding models 308, the computing system can obtain a vocal intermediate representation 312. The vocal intermediate representation 312 can be an intermediate representation, such as an embedding, of the vocal audio data 304. For example, the vocal intermediate representation 312 can be acoustic codes that are, or otherwise include, multidimensional vectors of acoustic codes (e.g., 12-dimensional vectors, etc.). The processing of vocal audio data 304 with the encoding models 308 will be discussed in greater detail with regards to FIG. 3B.

The instrumental audio data 306 of the training pair 302 can be processed with pre-trained encoding model(s) 314. By processing the instrumental audio data 306, the computing system can obtain an instrumental intermediate representation 316 of the instrumental audio data 306. In some implementations, the instrumental intermediate representation 316 can represent the instrumental audio data 306 in the same manner as that of the vocal intermediate representation 312. For example, the vocal intermediate representation 312 and the instrumental intermediate representation 316 can both be acoustic codes that are, or otherwise include, multidimensional vectors. In some implementations, the intermediate representations 312/314 can include semantic representation portions and acoustic representation portions (e.g., a coarse acoustic representation portion). For example, the intermediate representations 312/314 can be 8-dimensional vectors, with 4 dimensions dedicated to semantic representation and 4 dimensions dedicated to acoustic representation. Acoustic and semantic representation will be discussed in greater detail with regards to FIG. 3B.

The computing system can evaluate a loss function 318 that evaluates the instrumental intermediate representation 316. In some implementations, the loss function can evaluate a difference between the vocal intermediate representation 312 and the instrumental intermediate representation 316. The computing system can modify values of parameter(s) of one or more models of the encoding models 308. In such fashion, the computing system can train the encoding models 308 of the machine-learned generative audio model grouping 310 to predict an instrumental intermediate representation given vocal audio data.

As a particular example, the computing system can train the machine-learned generative audio model grouping 310 by considering training as a conditional generative modeling problem in which the training target is to model a distribution P (y|x) over appropriate instrumental waveforms y for vocal waveforms x, where both waveforms are monaural, T seconds in length, and sampled at some rate fₛ. In particular, both x and y can be vectors in [symbol] ^{f}^{ₛ}^{T}. Given vocals x′ from a user, music containing the vocals x′ can be generated by sampling y′˜P(y|x=x′) and linearly mixing the outputs (e.g., x′+y′).

To follow the depicted example, the encoding models 308 can be a single “sequence-to-sequence” language model that predicts instrumental semantic and coarse acoustic codes given vocal audio data 304 (e.g., vocal intermediate representation 312). In other words, the vocal intermediate representation 312 generated during training of the machine-learned generative audio model grouping can be a prediction of the instrumental intermediate representation 316. Specifically, input sequence \hat{x}=Feats (x) can be constructed, and “target” sequences ŷ=[ŷ₁ . . . ŷ_{f}_{ₖ}_{T}]∈( [symbol] ∪ [symbol] ^{f}^{ₖ}^{T} by concatenating [Sem(y); Coarse(y)], where fₖ=225 codes per second. Then, P_{θ,Π}(ŷ|\hat{x})=Πₜ₌₁^{Tf}^{ₖ}P_{θ}(ŷₜ|ŷ_{<t}, E_{Ø}(\hat{x}), where P_{θ}(ŷₜ|ŷ_{<t},E_{Π}(\hat{x})=Softmax(D_{θ}(ŷ_{<t}, E_{Ø}(\hat{x}))). Sequence encoder E_{Ø} and decoder D_{θ} can, in some implementations, be transformer models.

Once trained, the machine-learned generative audio model grouping 310 can be utilized to generate instrumental audio data to accompany vocal audio produced by a user. For example, instrumental semantic and coarse acoustic codes ŷ′˜P_{θ,Ø}(ŷ|\hat{x}=Feats (x′)). Semantic codes can then be dropped, and one of the pre-trained encoding models 314 can be utilized to generate fine acoustic codes given coarse codes. The generated coarse and fine acoustic codes can be combined as Combined(y′) and output x′+Dec(Combined(ŷ′)). It should be noted that, in some implementations, the original vocal audio data x′ is combined with the decoded instrumental Combined(ŷ′), as opposed to a version of the vocal input that has been processed by the codec.

FIG. 3B depicts a data flow diagram for processing vocal audio data with encoding models for training of model(s) included in a machine-learned generative audio model grouping according to some implementations of the present disclosure. Specifically, as described in FIG. 3A, the computing system can obtain vocal audio data 304. The computing system can then process the vocal audio data with the encoding models 308 of the machine-learned generative audio model grouping 310. In some implementations, the computing system can add noise 320 to the vocal audio data 304 prior to processing the vocal audio data 304 with the encoding models 308. For example, the computing system can obtain audio data comprising audio produced by white noise (e.g., “static” noise) and can mix the audio data with the vocal audio data 304. For another example, the computing system can add random or semi-random distortions or modifications to the vocal audio data 304 to add noise to the vocal audio data 304.

The noise 320 can be added to conceal barely-audible artifacts of original instrumentals that remain in source-separated vocal audio data 304. Specifically, a function can be defined Noise: X→X+Z, where Z˜ [symbol] (0, σ²)^{Tf}^{ₛ} and σ is a hyperparameter controlling the amplitude of the noise. Based on this function, Feats_{Def.}(Noise(x)) can be defined as a feature extraction function.

In some implementations, to process the vocal audio data 304, the computing system can process the vocal audio data with a pre-trained large language model 322 of the encoding models 308. For example, a generative machine-learned model that has already been trained for semantic text generation can be obtained by the computing system. The generative machine-learned model can include both an encoder portion trained to encode audio data to obtain a semantic representation of the audio data (e.g., a semantic intermediate representation, etc.), and a decoder portion trained to decode a semantic representation to obtain textual content. The pre-trained large language model 322 can be, or otherwise include, the encoding portion of the generative machine-learned model. Alternatively, in some implementations, the pre-trained large language model 322 can be a machine-learned model trained specifically to generate a semantic representation 324 of vocal audio data.

In some implementations, rather than processing the vocal audio data 304 directly, the computing system can process data derived from the vocal audio data 304 with the pre-trained large language model 322. Specifically, in some implementations, the vocal audio data 304 can be processed using speech recognition techniques prior to processing with the pre-trained large language model 322. For example, the pre-trained large language model 322 may only be trained to process textual content inputs. The vocal audio data 304 can include spoken utterances that collectively vocalize the lyrics of a song. The computing system can perform the speech recognition technique (e.g., processing with a speech recognition model, application of a speech recognition algorithm, etc.) to the vocal audio data 304 to obtain a speech recognition output (not illustrated) that includes textual content that transcribes the spoken utterances of the vocal audio data 304. The computing system can then process the speech recognition output with the pre-trained large language model 322.

Alternatively, in some implementations, the vocal audio data 304 may be processed using some other type of model or algorithm to obtain data derived from the vocal audio data 304 that can be processed using the pre-trained large language model 322. For example, the pre-trained large language model 322 may be a model trained to generate semantic representations of visual content (e.g., images, video, 3D modeling information, etc.). The computing system can process the vocal audio data 304 with a model trained to generate visual content from an audio data input. The computing system can then process the visual content with the pre-trained large language model 322 to obtain the semantic representation 324.

In particular, in some implementations, function Feats: [symbol] ^{f}^{ₛ}^{T}→ [symbol] ^{f}^{ₓ}^{T} can be used to extract discrete features from the vocal audio data 304. For example, a naïve default can be utilized with a featurization schema of Feats_{Def.}(x)=(Sem(x); Coarse(x)], i.e., fₓ=225 Hz and [symbol] = [symbol] =S∪ [symbol] .

The computing system can process the vocal audio data 304, or data derived therefrom, to obtain semantic representation 324. The computing system can process the semantic representation 324 with a machine-learned audio representation model 326 to obtain a coarse acoustic representation 328 of the vocal audio data 304. The machine-learned audio representation model 326 can be any type or manner of machine-learned model that can be trained to generate coarse acoustic representations of vocal audio data given various input(s). For example, the machine-learned audio representation model 326 can be a transformer model with an encoder-decoder architecture (e.g., a model that includes both encoding and decoding portions). In some implementations, the computing system can process only the semantic representation 324 with the machine-learned audio representation model 326 to obtain the coarse acoustic representation 328. Alternatively, in some implementations, the computing system can process only the vocal audio data 304 with the machine-learned audio representation model 326 to obtain the coarse acoustic representation 328. Alternatively, in some implementations, the machine-learned audio representation model 326 can process both the semantic representation 324 and the vocal audio data 304 to obtain the coarse acoustic representation 328.

Collectively, the computing system can process the vocal audio data 304 with the encoding models 308 of the machine-learned generative audio model grouping 310 to obtain the vocal intermediate representation 312. The vocal intermediate representation can include both the semantic representation 324 and the coarse acoustic representation 328.

As a particular example, the machine-learned audio representation model 326 can generate the coarse acoustic representation 328 via a discrete codec to produce a coarse acoustic representation 328 that is, or otherwise includes, discrete audio codes. For example, the machine-learned audio representation model 326 can be used to generate discrete audio codes with a discrete codec, a pair of functions Enc: [symbol] ^{f}^{ₛ}^{T}→ [symbol] ^{f}^{ₖ}^{T} and Dec: [symbol] ^{f}^{ₖ}^{T}→ [symbol] ^{f}^{ₛ}^{T}, where [symbol] is some finite vocabulary, fₖ is the audio code rate, and Dec approximates Enc⁻¹.

For example, using Enc and Dec, a “proxy” distribution can be modeled over codes produced by Enc, and approximate the distribution over waveforms by leveraging Dec. Specifically, for an unconditional setting where the target is to model a distribution over waveforms ω, P(\hat{ω}) can instead be modeled as a proxy where \hat{ω}=Enc(ω). To sample audio from this distribution, \hat{ω}′˜P(\hat{ω}) can first be sampled to output Dec(\hat{ω}′). Because fₖ<<fₛ, it is empirically tractable to model this proxy.

FIG. 3C depicts a data flow diagram for processing instrumental audio data with pre-trained encoding models for training of model(s) included in a machine-learned generative audio model grouping according to some implementations of the present disclosure. As described with regards to FIG. 3A, the instrumental audio data 306 can be processed with pre-trained encoding models 314 to obtain an instrumental intermediate representation 316.

The pre-trained encoding models 314 can be any type, manner, and/or collection of encoding models sufficient to generate data that is representative of the instrumental audio data 306. For example, in some implementations, the pre-trained encoding models 314 can include a pre-trained large language model 329. In some implementations, the pre-trained large language model 329 can be the same model as the pre-trained large language model 322 of the machine-learned generative audio model grouping 310 as described in FIG. 3B. Alternatively, in some implementations, the pre-trained large language model 322 can be some other encoding model that generates a semantic representation 330 of the instrumental audio data 306.

The computing system can process the instrumental audio data 306 and/or the semantic representation 330 with a pre-trained encoding model 332 to obtain a coarse acoustic representation 334. In some implementations, the pre-trained encoding model 332 can be an encoding portion of a generative audio model with an encoder-decoder architecture. The pre-trained encoding model 332 can be trained to generate coarse acoustic codes that can be decoded by the decoding portion of the generative audio model. The instrumental intermediate representation 316 can include both the semantic representation 330 and the coarse acoustic representation 334.

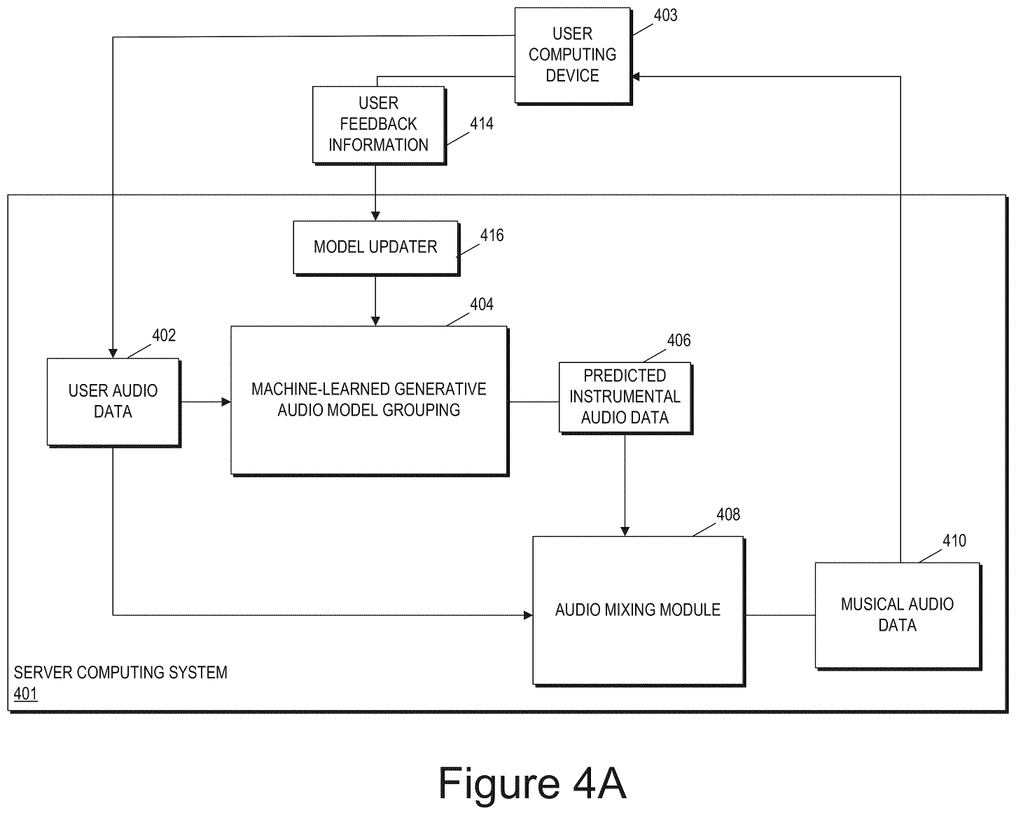

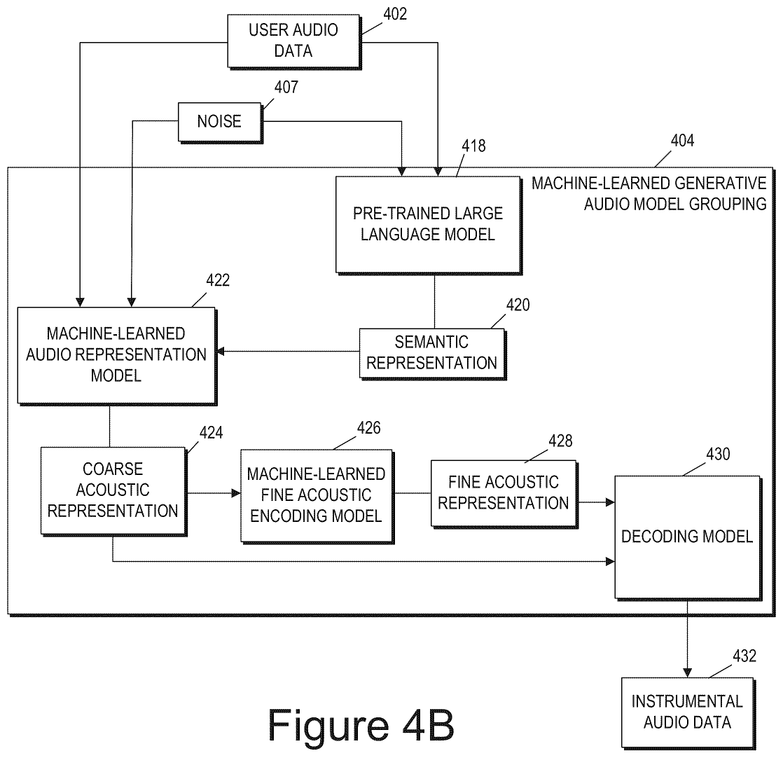

FIG. 4A depicts a data flow diagram for generating instrumental audio data to accompany vocal audio produced by a user with a machine-learned generative audio model grouping of a server computing system according to some implementations of the present disclosure. In particular, a server computing system 401 (e.g., a cloud-based system, a distributed system, etc.) can obtain user audio data 402 from a user computing device 403. User audio data 402 can include vocal audio produced by a user (e.g., a recording of the user singing, etc.). For example, a user associated with the user computing device 403 may record themselves speaking using an audio capture device associated with the user computing device 403. The user computing device 403 can perform initial processing of the user audio data (e.g., audio cleanup algorithms, encoding, codec application, etc.) and can transmit the user audio data 402 to the

The server computing system 401 can process the user audio data 402 with machine-learned generative audio model grouping 404 (e.g., machine-learned generative audio model grouping 310 of FIG. 3A-3B, etc.). Specifically, the server computing system 401 can process the user audio data 402 with one or more of the machine-learned models included in the machine-learned generative audio model grouping 404 to obtain predicted instrumental audio data 406. Processing of the user audio data 402 with the machine-learned generative audio model grouping 404 will be discussed in greater detail with regards to FIG. 4B.

Predicted instrumental audio data 406 can include instrumental audio that is predicted to accompany the vocal audio included in user audio data 402. As a particular example, assume that the vocal audio of user audio data 402 is a recording of a user singing, and that the characteristics of the user's vocals (e.g., pitch, tone, pace, semantic lyrical meaning, volume, etc.) are similar to vocals commonly produced by musicians within the Pop genre. The predicted instrumental audio data 406 can include instrumental audio that (a) matches the characteristics of the user's vocals and (b) is produced by instruments commonly utilized within the Pop genre (e.g., digital audio, guitar, drums, etc.).

In some implementations, the user audio data can further include information indicative of a particular type or genre of instrumental audio. For example, the user may provide user audio data 402 and also provide information indicating that they desire instrumental audio similar to that of the Country genre. Additionally, or alternatively, in some implementations, the user can specifically indicate which instruments are to be included in the predicted instrumental audio data 406.

The server computing system 401 can mix user audio data 402 and predicted instrumental audio data 406 using audio mixing module 408 to obtain musical audio data 410. The audio mixing module 408 can perform audio mixing using any type or manner of conventional audio mixing technique (e.g., a trained audio mixing model, audio mixing algorithms, etc.). The musical audio data 410 can include audio of a musical work that includes vocal audio data (e.g., vocal audio provided by the user) and instrumental audio data (e.g., the predicted instrumental audio data 406) that collectively form a musical work. The server computing system 401 can transmit the musical audio data 410 to the user computing device 403.

In some implementations, the user computing device 403 can cause playback of the musical audio data 410 for the user associated with the user computing device 403. In response, the user can provide user feedback information 414 (i.e., user feedback data 414). The user feedback information 414 can indicate the user's feedback for particular characteristics of the musical audio data 410 (e.g., whether the musical audio data 410 includes audio of the correct genre, whether the user is satisfied with the musical audio data 410, etc.). The user computing device 403 can transmit the user feedback information 414 to the server computing system 401. Based on the user feedback information 414, the server computing system 401 can update one or more model(s) of the machine-learned generative audio model grouping 404. In such fashion, the server computing system 401 can iteratively personalize the machine-learned generative audio model grouping 404 to provide more accurate predicted instrumental audio data 406 for the user associated with the user computing device 403.

It should be noted that some, or all, of the operations described with regards to the server computing system 401 of FIG. 4A can also be performed using the user computing device 403 of FIG. 4A. For example, the server computing system 401 can provide the trained machine-learned generative audio model grouping 404 to the user computing device 403, or the user computing device 403 can locally train the machine-learned generative audio model grouping 404. The user computing device 403 can perform the operations of receiving the user audio data 402, processing the user audio data 402 with the machine-learned generative audio model grouping 404 to obtain the predicted instrumental audio data, mixing the user audio data 402 and the predicted instrumental audio data 406 with the audio mixing module 408, etc. as described previously with regards to the server computing system 401. Rather than transmitting the musical audio data 410, the user computing device 403 can directly cause playback of the musical audio data 410, and in response, the user computing device 403 can receive user feedback information 414. The user computing device can then personalize the machine-learned generative audio model grouping 404 using the user feedback information 414.

FIG. 4B is a data flow diagram for generating predicted instrumental audio data using a machine-learned generative audio model grouping according to some implementations of the present disclosure. More specifically, the machine-learned generative audio model grouping 404 can include a machine-learned audio representation model 422. The machine-learned audio representation model 422 can be any type or manner of model sufficient to generate coarse acoustic representations 424. For example, the machine-learned audio representation model 422 can be an encoder-decoder transformer model.

In some implementations, the machine-learned audio representation model 422 can process the user audio data 402 directly to obtain the coarse acoustic representation 424. Alternatively, in some implementations, the machine-learned generative audio model grouping 404 can include a pre-trained large language model 418. The pre-trained large language model 4118 can process the user audio data to generate a semantic representation 420 (e.g., as described with regards to the pre-trained large language model 322 of FIG. 3B, etc.). In some implementations, the machine-learned audio representation model 422 can process only the semantic representation 420 to generate the coarse acoustic representation 424. Alternatively, in some implementations, the machine-learned audio representation model 422 can process both the semantic representation 420 and the user audio data 402 to generate the coarse acoustic representation 424.

In particular, in some implementations, the machine-learned generative audio model grouping 404 can utilize smaller models to model a joint distribution over acoustic codes and low-rate semantic codes. To do so, the pre-trained large language model 418 can process the user audio data 402 to generate semantic representations as represented by Sem: [symbol] ^{f}^{ₛ}^{T}→ [symbol] ^{25T}. The pre-trained large language model 418 (e.g., a semantic representation model) can operate at 25 Hz and can be trained with a self-supervised loss instead of an acoustic reconstruction loss. In some implementations, the pre-trained large language model 418 can consist of intermediate representations from a pre-trained language model that have been quantized with k-means, where k=| [symbol] |=1024.

In some implementations, the user audio data 402 can be processed alongside noise 407. The noise 407 can be audio data including audio data of white noise, or can be some other manner of noise (e.g., randomized data, etc.). For example, in some implementations, the machine-learned audio representation model 422 can process the user audio data 402 and noise 407 to generate the coarse acoustic representation. For another example, the pre-trained large language model 418 can process the noise 407 and the user audio data 402 to generate the semantic representation 420. For yet another example, the machine-learned audio representation model 422 can process the noise 407 and the semantic representation 420 to generate the coarse acoustic representation 424.

The machine-learned generative audio model grouping 404 can include a machine-learned fine acoustic encoding model 426. The machine-learned fine acoustic encoding model 426 can be an encoding model trained to generate fine acoustic representations (e.g., i.e., encodings) from coarse acoustic representations. For example, the machine-learned fine acoustic encoding model 426 can process the coarse acoustic representation 424 to generate fine acoustic representation 428. In some implementations, the machine-learned fine acoustic encoding model 426 can be the pre-trained encoding model utilized to generate target coarse acoustic representations during training of the machine-learned generative audio model grouping 404 (e.g., the pre-trained encoding model 332 of FIG. 3C). Alternatively, the machine-learned fine acoustic encoding model 426 can be a different encoding model that generates fine acoustic representations in a manner different than the machine-learned audio representation model 422.

The machine-learned generative audio model grouping 404 can include a decoding model 430. The decoding model 430 can be a machine-learned model trained to generate instrumental audio data based on fine acoustic representations. In some implementations, the decoding model 430 can be a pre-trained decoding model associated with the fine acoustic representation model 426. For example, the machine-learned fine acoustic encoding model 426 and the decoding model 430 can be models of an encoder-decoder architecture that were trained concurrently to generate audio data. The decoding model can process the fine acoustic representation to generate the instrumental audio data 432.

As described previously, the machine-learned fine acoustic encoding model 426 can also be the model used to generate target coarse acoustic representations during training of the machine-learned generative audio model grouping 404 (e.g., the pre-trained encoding model 332 of FIG. 3C.) In particular, the machine-learned fine acoustic encoding model 426 can be a pre-trained encoder Enc: [symbol] ^{f}^{ₛ}^{T}→ [symbol] ^{50T×12} and a corresponding decoder Dec where fₛ=16 kHz and | [symbol] |=1024. In this example, the outputs from the machine-learned fine acoustic encoding model 426 can be referred to as acoustic codes. The machine-learned fine acoustic encoding model 426 can utilize a residual vector quantization scheme that produces 12-dimensional vectors of acoustic codes at a rate of 50 Hz—the first 4 dimensions can be coarse acoustic codes and the remaining 8 dimensions can be fine acoustic codes. For example, the coarse acoustic representation 334 generated by the pre-trained encoding model 332 of FIG. 3C can be coarse acoustic codes, and the fine acoustic representation 428 can be fine acoustic codes.

In particular, flattened coarse acoustic codes for waveforms w can be represented as Coarse(ω) and flattened fine acoustic codes as Fine(ω). As described previously, the decoding model 430 can be a model paired to the machine-learned fine acoustic encoding model 426 that is trained to decode encodings generated by the machine-learned fine acoustic encoding model 426. As such, due to its residual quantization scheme, the decoding model 430 can decode audio from coarse codes alone, although decoding from both coarse AND fine can, in some implementations, yield higher audio fidelity. Thus, it should be understood that, to generate the instrumental audio data 432, the decoding model 430 may decode the coarse acoustic representation 424 and/or the fine acoustic representation 428.

Overall, in some implementations, processing of the user audio data 402 with the machine-learned generative audio model grouping 404 can be a cascading processing of the user audio data 402 with three models that generate increasingly high-rate codes. In particular, these cascading operations can be represented as P(Sem(ω), Enc(ω)=P(Fine(ω)|Coarse(ω)). P(Coarse(ω)|Sem(ω)). P(Sem(ω)), with the assumption that Fine(ω) [symbol] Sem(ω)|Coarse(ω). In other words, it can be assumed that semantic codes may be unhelpful for generating fine acoustic codes given coarse acoustic codes. In some implementations, each model can be an autoregeressive, decoder-only transformer model (e.g., a language model, etc.) that is trained separately, and conditioning can be achieved by concatenating the two sequences. To generate audio with the machine-learned generative audio model grouping 404, the three generative models can first be sampled in series. Then, the generated semantic codes can be discarded as a byproduct and the generated acoustic codes can be fed to Dec (e.g., decoding model 430) to produce a waveform.

In some implementations, rather than directly modeling distributions over instrumental waveforms y for vocal waveforms x, the machine-learned generative audio model grouping 404 can model proxy distributions over instrumental codes given vocal codes. Specifically, P (Sem (y), Enc (y)|Feats (x)), where Sem and Enc are machine-learned models included in the machine-learned generative audio model grouping 404 and Feats: [symbol] ^{f}^{ₛ}^{T}→ [symbol] ^{f}^{ₓ}^{T} is a function to extract discrete features from vocals x. For example, the three-stage factorization described previously can be utilized, and represented as

$$P ( S e m ( y ) , En c ( y ) \vert Feats ( x ) ) = P ( Fine ( y ) \vert Coarse ( y ) ) \cdot P ( Coarse ( y ) \vert Sem ( y ) , Feats ( x ) ) \cdot P ( S e m ( y ) \vert Feats ( x ) ) ,$$

with an analogous independence assumption. In other words, that the fine instrumental codes can be reconstructed from coarse instrumental codes alone.

### Example Methods

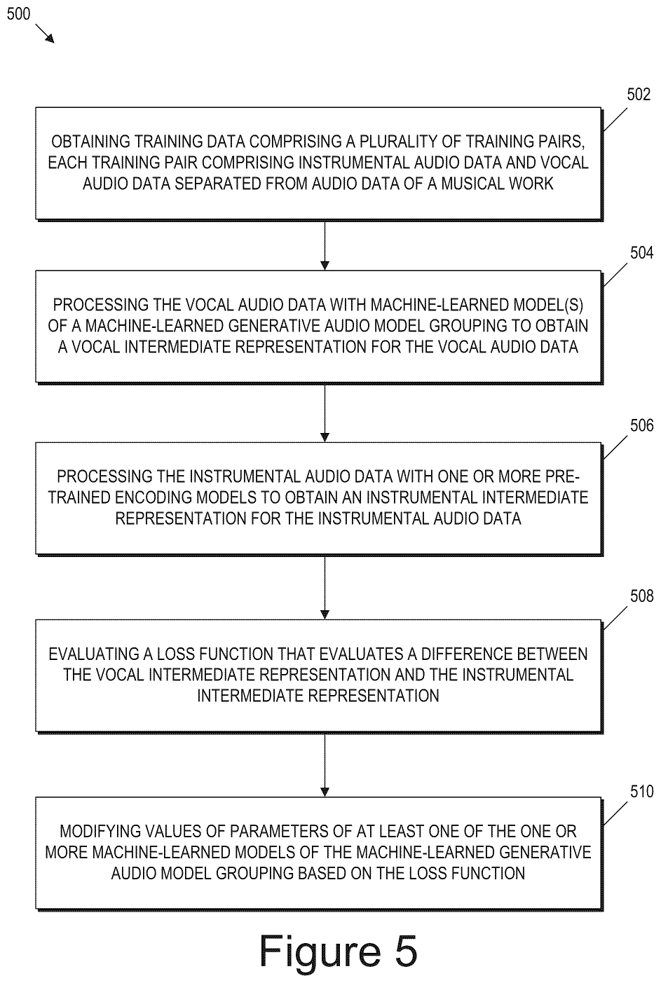

FIG. 5 depicts a flow chart diagram of an example method 500 to perform training of a machine-learned generative audio model grouping according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system can obtain training data (e.g., data utilized to train machine-learned model(s)) that includes a plurality of training pairs. Each training pair can include instrumental audio data (e.g., audio data that records instrumental audio within a musical work) and vocal audio data (e.g., audio data that records vocal audio (e.g., singing)) separated from audio data of a musical work of a respective plurality of musical works. For example, the computing system may perform data gathering operations (e.g., web scraping, data pre-processing, etc.) to obtain the training data. For a more particular example, the computing system can obtain information indicating the file locations of audio data for a plurality of musical works, and can receive the audio data for the plurality of musical works to create the training pairs.

At 504, the computing system can, for one or more training pairs of the plurality of training pairs, process the vocal audio data with one or more machine-learned models of a plurality of machine-learned models of a machine-learned generative audio model grouping to obtain a vocal intermediate representation for the vocal audio data.

At 506, the computing system can process the instrumental audio data with one or more pre-trained encoding models to obtain an instrumental intermediate representation for the instrumental audio data.

At 508, the computing system can evaluate a loss function that evaluates a difference between the vocal intermediate representation and the instrumental intermediate representation.

At 510, the computing system can modify values of parameters of at least one of the one or more machine-learned models of the machine-learned generative audio model grouping based on the loss function.

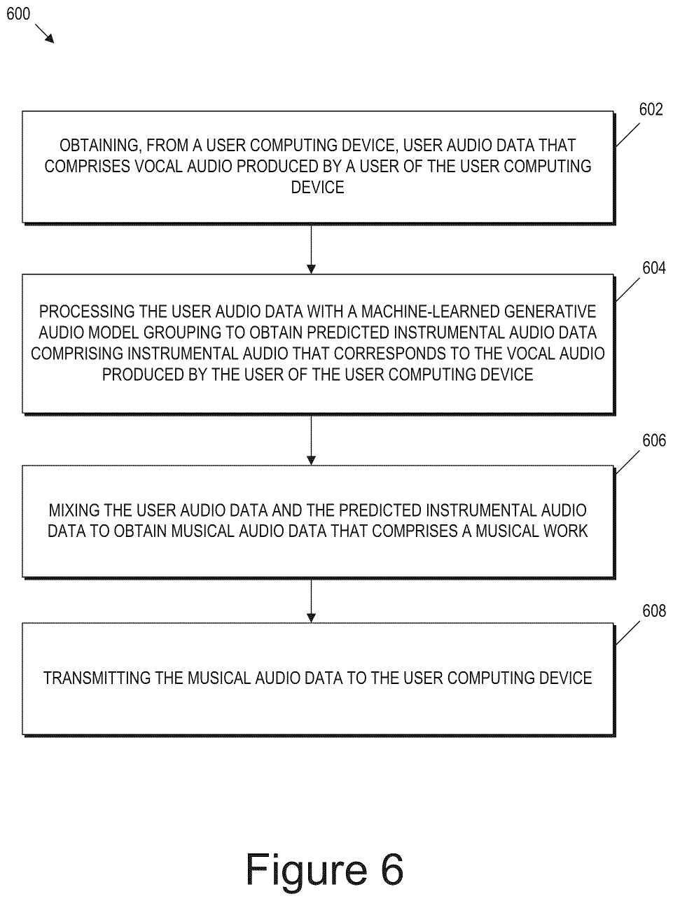

FIG. 6 depicts a flow chart diagram of an example method 600 to provide machine-learned generative audio services for generation of instrumental accompaniments according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain, from a user computing device, user audio data that includes vocal audio produced by a user of the user computing device. For example, the computing system can be a server computing system that provides machine-learned generative audio services. The computing system can receive request information from the user computing device indicating a request for the generation of predicted instrumental data. The user computing device can also provide the user audio data alongside the request information. Alternatively, in some implementations, the computing system can obtain the user audio data from the user computing device indirectly. For example, the computing system can be a compute node within a computing network that broadly provides multimedia services, such as machine-learned generative audio services. A gateway node in the computing network may receive the user audio data from the user computing device, and then provide the user audio data to the computing system. As such, it should be broadly understood that the computing system can acquire the user audio data from the user computing device directly or indirectly.

At 604, the computing system can process the user audio data with a machine-learned generative audio model grouping to obtain predicted instrumental audio data that includes instrumental audio that corresponds to the vocal audio produced by the user of the user computing device. The machine-learned generative audio model grouping can include a plurality of machine-learned models. At least one of the plurality of machine-learned models can be trained using training data that includes, or is derived from, a plurality of musical works, each musical work being separated into instrumental audio data and vocal audio data.

At 606, the computing system can mix the user audio data and the predicted instrumental audio data to obtain musical audio data that comprises a musical work. As described previously, the computing system can mix the user audio data utilizing any type or manner of conventional audio mixing processes. For example, the computing system can apply an audio mixing algorithm to the audio data. For another example, the computing system an process the audio data with a machine-learned model trained to mix audio data. For yet another example, the computing system can transmit the audio data to a compute node that provides audio mixing services (e.g., a computing system, computing device, virtualized compute node, etc.) and can receive mixed audio data in response.

At 608, the computing system can transmit the musical audio data to the user computing device. For example, the computing system can transmit the musical audio data to the user computing device via a wireless network.

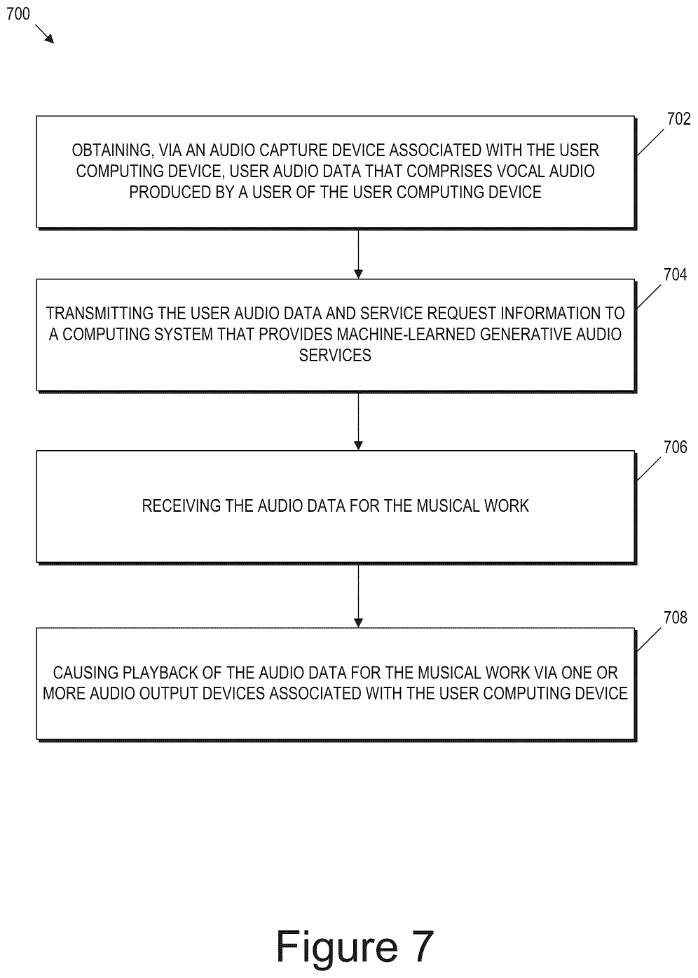

FIG. 7 depicts a flow chart diagram of an example method 700 to utilize machine-learned generative audio services to provide musical accompaniments to user audio data that includes vocal audio from the user according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a user computing device can obtain, via an audio capture device associated with the user computing device, user audio data that includes vocal audio produced by a user of the user computing device. For example, the user computing device can be a smartphone device with a built-in microphone. The user computing device can capture audio via the built-in microphone and store the audio as user audio data. For another example, the user computing device can be communicatively coupled to a wireless device that includes a microphone, such as a wireless headset or wireless earbuds. The user computing device can receive the audio data recorded at the wireless device via a wireless connection.

At 704, the user computing device can transmit the user audio data and service request information to a computing system that provides machine-learned generative audio services. The service request information is indicative of a request for audio data for a musical work that includes a mix of the user audio data and predicted instrumental audio data comprising predicted instrumental audio that accompanies the vocal audio.

At 706, the user computing device can, responsive to transmitting the user audio data and the service request information, receive, from the computing system, the audio data for the musical work that comprises the mix of the user audio data and the predicted instrumental audio data comprising the predicted instrumental audio that accompanies the vocal audio.

At 708, the user computing device can cause playback of the audio data for the musical work via one or more audio output devices associated with the user computing device. For example, the user computing device can be a laptop device with built-in speakers. The user computing device can send audio signals that carry the audio data to the built-in speakers to cause playback of the audio data. For another example, the user computing device can be communicatively coupled to a wireless speaker. The user computing device can wirelessly signal the audio data to the wireless speaker to cause playback of the audio data.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
obtaining, by a computing system comprising one or more computing devices, training data comprising a plurality of training pairs, each training pair comprising instrumental audio data and vocal audio data separated from audio data of a musical work of a respective plurality of musical works;
for one or more training pairs of the plurality of training pairs:
processing, by the computing system, the vocal audio data with one or more machine-learned models of a plurality of machine-learned models of a machine-learned generative audio model grouping to obtain a vocal intermediate representation for the vocal audio data;
processing, by the computing system, the instrumental audio data with one or more pre-trained encoding models to obtain an instrumental intermediate representation for the instrumental audio data;
evaluating, by the computing system, a loss function that evaluates a difference between the vocal intermediate representation and the instrumental intermediate representation; and
modifying, by the computing system, values of parameters of at least one of the one or more machine-learned models of the machine-learned generative audio model grouping based on the loss function.

2. The computer-implemented method of claim 1, wherein the vocal intermediate representation comprises a semantic representation portion and a coarse acoustic representation portion; and
wherein processing the vocal audio data with the one or more machine-learned models of the machine-learned generative audio model grouping to obtain the vocal intermediate representation comprises:
processing, by the computing system, the vocal audio data with a pre-trained large language model of the machine-learned generative audio model grouping to obtain the semantic representation portion.

3. The computer-implemented method of claim 2, wherein processing the vocal audio data with the one or more machine-learned models of the machine-learned generative audio model grouping to obtain the intermediate representation of the vocal audio data further comprises:
processing, by the computing system, the semantic representation portion with a machine-learned audio representation model of the machine-learned generative audio model grouping to obtain the coarse acoustic representation portion.

4. The computer-implemented method of claim 3, wherein modifying values of parameters of at least one of the one or more machine-learned models of the machine-learned generative audio model grouping comprises modifying, by the computing system, values of parameters of the machine-learned audio representation model of the machine-learned generative audio model grouping based on the loss function.

5. The computer-implemented method of claim 3, wherein, prior to processing the vocal audio data with the pre-trained large language model, the method comprises:
mixing, by the computing system, audio data comprising white noise audio with the vocal audio data.

6. The computer-implemented method of claim 3, wherein the instrumental intermediate representation comprises a semantic representation portion and a coarse acoustic representation portion; and
wherein processing the instrumental audio data with the one or more pre-trained encoding models comprises:
processing, by the computing system, the instrumental audio data with a first pre-trained encoding model of the one or more pre-trained encoding models to obtain the semantic representation portion of the intermediate representation of the instrumental audio; and
processing, by the computing system, the instrumental audio data with a second pre-trained encoding model of the one or more pre-trained encoding models to obtain the coarse acoustic representation portion of the intermediate representation of the instrumental audio data.

7. The computer-implemented method of claim 6, wherein the first pre-trained encoding model comprises the pre-trained large language model of the machine-learned generative audio model grouping.

8. The computer-implemented method of claim 3, wherein the method further comprises:
obtaining, by the computing system, user audio data that comprises vocal audio produced by a user;
processing, by the computing system, the user audio data with the machine-learned generative audio model grouping to obtain predicted instrumental audio data corresponding to the user audio data; and
mixing, by the computing system, the user audio data with the predicted instrumental audio data to obtain audio data comprising a musical work.

9. The computer-implemented method of claim 8, wherein processing the user audio data with the machine-learned generative audio model grouping to obtain the predicted instrumental audio data corresponding to the user audio data comprises:
processing, by the computing system, the user audio data with the machine-learned audio representation model of the machine-learned generative audio model grouping to obtain a coarse acoustic representation of the user audio data;
processing, by the computing system, the coarse acoustic representation of the user audio data with a machine-learned fine acoustic encoding model of the machine-learned generative audio model grouping to obtain a fine acoustic representation of the user audio data; and
processing, by the computing system, the coarse acoustic representation and the fine acoustic representation with a decoding model of the machine-learned generative audio model grouping to obtain the predicted instrumental audio data.

10. The computer-implemented method of claim 9, wherein the machine-learned audio representation model comprises an encoder-decoder transformer model; and wherein the decoding model is trained to decode fine acoustic representations generated by the machine-learned fine acoustic encoding model.

11. The computer-implemented method of claim 8, wherein obtaining the user audio data that comprises the vocal audio produced by the user further comprises mixing, by the computing system, the audio data comprising white noise audio with the user audio data.

12. One or more non-transitory computer-readable storage media that store instructions that, when executed by one or more processors, cause the one or more processors to perform operations, the operations comprising:
obtaining, from a user computing device, user audio data that comprises vocal audio produced by a user of the user computing device;
processing the user audio data with a machine-learned generative audio model grouping to obtain predicted instrumental audio data comprising instrumental audio that corresponds to the vocal audio produced by the user of the user computing device, wherein the machine-learned generative audio model grouping comprises a plurality of machine-learned models, and wherein at least one of the plurality of machine-learned models is trained using training data that comprises, or is derived from, a plurality of musical works, each musical work being separated into instrumental audio data and vocal audio data;
mixing the user audio data and the predicted instrumental audio data to obtain musical audio data that comprises a musical work; and
transmitting the musical audio data to the user computing device.

13. The one or more non-transitory computer-readable storage media of claim 12, wherein processing the user audio data with the machine-learned generative audio model grouping comprises:
processing the user audio data with a machine-learned audio representation model of the machine-learned generative audio model grouping to obtain a coarse acoustic representation of the user audio data;
processing the coarse acoustic representation of the user audio data with a machine-learned fine acoustic encoding model of the machine-learned generative audio model grouping to obtain a fine acoustic representation of the user audio data; and
processing the coarse acoustic representation and the fine acoustic representation with a decoding model of the machine-learned generative audio model grouping to obtain the predicted instrumental audio data, wherein the decoding model is trained to decode fine acoustic representations generated by the machine-learned fine acoustic encoding model.

14. The one or more non-transitory computer-readable storage media of claim 13, wherein processing the user audio data with the machine-learned audio representation model comprises:
processing the user audio data with a pre-trained large language model to obtain a semantic intermediate representation of the user audio data; and
processing the semantic intermediate representation with the machine-learned audio representation model to obtain the coarse acoustic representation of the user audio data.

15. The one or more non-transitory computer-readable storage media of claim 12, wherein the operations further comprise:
responsive to transmitting the musical audio data to the user computing device, receiving, from the user computing device, user feedback data descriptive of feedback from the user associated with the musical audio data; and
based at least in part on the user feedback data, adjusting values of parameters of at least one machine-learned model of the plurality of machine-learned models of the machine-learned generative audio model grouping.

16. The one or more non-transitory computer-readable storage media of claim 15, wherein the operations further comprise transmitting, to the user computing device, data indicative of the adjustments to the values of the parameters of the at least one machine-learned model of the plurality of machine-learned models of the machine-learned generative audio model grouping.

17. The one or more non-transitory computer-readable storage media of claim 12, wherein the training data that comprises, or is derived from, the plurality of musical works comprises a plurality of training pairs respectively associated with the plurality of musical works, wherein each training pair comprises instrumental audio data and vocal audio data separated from the audio data of an associated musical work of the plurality of musical works.

18. A user computing device, comprising:
one or more processors; and
one or more non-transitory computer-readable media that store instructions that, when executed by the one or more processors, cause the one or more processors to perform operations, the operations comprising:
obtaining, via an audio capture device associated with the user computing device, user audio data that comprises vocal audio produced by a user of the user computing device;
processing the user audio data with a machine-learned generative audio model grouping to obtain predicted instrumental audio data comprising instrumental audio that corresponds to the vocal audio produced by the user of the user computing device, wherein the machine-learned generative audio model grouping comprises a plurality of machine-learned models, and wherein at least one of the plurality of machine-learned models is trained using training data that comprises, or is derived from, a plurality of musical works, each musical work being separated into instrumental audio data and vocal audio data;
mixing the user audio data and the instrumental audio data to obtain musical audio data that comprises a musical work; and
providing the musical audio data for playback for the user.

19. A user computing device, comprising:
one or more processors; and
one or more non-transitory computer-readable media that store instructions that, when executed by the one or more processors, cause the one or more processors to perform operations, the operations comprising:
obtaining, via an audio capture device associated with the user computing device, user audio data that comprises vocal audio produced by a user of the user computing device;
transmitting the user audio data and service request information to a computing system that provides machine-learned generative audio services, wherein the service request information is indicative of a request for audio data for a musical work that comprises a mix of the user audio data and predicted instrumental audio data comprising predicted instrumental audio that accompanies the vocal audio;
responsive to transmitting the user audio data and the service request information, receiving, from the computing system, the audio data for the musical work that comprises the mix of the user audio data and the predicted instrumental audio data comprising the predicted instrumental audio that accompanies the vocal audio; and
causing playback of the audio data for the musical work via one or more audio output devices associated with the user computing device.

20. The user computing device of claim 19, wherein the operations further comprise:
obtaining, via a user interface, user feedback data descriptive of feedback from the user of the user computing device associated with the predicted instrumental audio; and
transmitting information indicative of the user feedback data to the computing system.
